(19) United States
(12) Patent Application Publication
(10) Pub. No.: US 2005/0279332 A1
(43) Pub. Date: Dec. 22, 2005

(54) Far infrared fuel-saver

(76) Inventor: Jun Zhi Zhang, Taichung City (TW)

Correspondence Address: CHARLES E. BAXLEY, ESQ., 90 JOHN STREET, THIRD FLOOR, NEW YORK, NY, 10038, US

(21) Appl. No.: 11/147,131

(22) Filed: Jun. 7, 2005

(30) Foreign Application Priority Data
Jun. 16, 2004 (TW) 093209491

(51) Int. Cl. F02M 27/00

(52) U.S. Cl. 123/538

(57) ABSTRACT

There is disclosed a far infrared fuel-saver capable of mincing liquid fuel. The far infrared fuel-saver includes a semiconductor electro-thermal film and two electrode strips provided on the semiconductor electro-thermal film. When a current goes to semiconductor electro-thermal film through the electrode strips, the temperature of the semiconductor electro-thermal film rises fast. The penetration and radioactivity become high so that the far infrared light can effectively penetrates the pipe in order to mince the liquid fuel. Thus, the combustion of the liquid fuel is complete, and the liquid fuel is saved, and the deposition of carbon is little. Therefore, the efficiency in generating energy through combusting the liquid fuel is increased, and the exhaust cleansed.

### BACKGROUND OF INVENTION

1. Field of Invention

The present invention relates to a far infrared fuel-saver.

2. Related Prior Art

In an engine such as a combustion engine and an internal combustion engine, kinetic energy is generated by means of combusting liquid fuel such as petroleum. Whether the liquid fuel is completely combusted not only influences the efficiency of the engine in generating the kinetic energy but also determines whether carbon will deposit in the engine. If the combustion of the liquid fuel is incomplete, the exhaust will contain a large amount of carbon and pollute the environment and wear away the engine excessively. To solve these problems, there are provided various approaches such as adding a combustion-supporting agent, using a fuel-saver and using a de-carburizing device.

Among these approaches, a far infrared fuel-saver is most promising. An ordinary far infrared fuel-saver provides far infrared light in the vicinity of a pipeline for transferring the liquid fuel because of the penetration and radioactivity of the far infrared light. When the liquid fuel goes through a section of the pipeline subject to the far infrared light, the molecules of the liquid fuel are minced so that the liquid fuel can be combusted more completely in the engine and that the efficiency of the engine in generating the kinetic energy can be increased in order to save the liquid fuel. Because the percentage of the combustion of the liquid fuel is increased, the carbon content and incompletely combusted liquid fuel in the exhaust are reduced in order to reduce the pollution on the environment. Furthermore, there is reduced the deposition of carbon in the engine as well as the wearing-out of the engine. A vicious cycle is avoided, and the life cycle of the engine is extended.

However, at the normal temperature, the ordinary far infrared fuel-saver fails to provide far infrared light of adequate radioactivity and penetration. In addition, wishing to increase the power of the kinetic energy generated by means of the engine, a user increases the rate of the provision of the liquid fuel to the engine. Thus, a time interval during which the liquid fuel is subject to the far infrared light is reduced. The degree of the mincing of the molecules of the liquid fuel is reduced. The performance of the far infrared fuel-saver is compromised. Therefore, reduced is the economy of the liquid fuel as well as that of the far infrared fuel-saver.

The present invention is therefore intended to obviate or at least alleviate the problems encountered in prior art.

### SUMMARY OF INVENTION

The primary objective of the present invention is therefore to provide a far infrared fuel-saver capable of emitting far infrared light of adequate penetration and radioactivity.

According to the present invention, the far infrared fuel-saver includes a semiconductor electro-thermal film and two electrode strips provided. The semiconductor electro-thermal film is capable of emitting a lot of far infrared light at the normal temperature. The electrode strips are secured to a side of the semiconductor electro-thermal film. The electrode strips can be made of various electrically conductive materials. A gap is left between the electrode strips.

Therefore, the molecules of liquid fuel can be well minced so that the liquid fuel can be combusted completely in order to save the liquid fuel and reduce the deposition of carbon. Furthermore, the efficiency in generating energy through the combustion of the liquid fuel is increased, and the exhaust is cleansed. Hence, the economy is increased.

Other advantages and novel features of the invention will become more apparent from the following detailed description in conjunction with the drawings.

### BRIEF DESCRIPTION OF DRAWINGS

The present invention will be described through detailed description of the preferred embodiment referring to the drawings.

FIG. 1 is an exploded view of a far infrared fuel-saver according to the preferred embodiment of the present invention.

FIG. 2 is a perspective view of the far infrared fuel-saver shown in FIG. 1.

FIG. 3 is a block diagram of a machine equipped with the far infrared fuel-saver shown in FIG. 1.

FIG. 4 is a block diagram of another machine equipped with the far infrared fuel-saver shown in FIG. 1.

### DETAILED DESCRIPTION OF PREFERRED EMBODIMENT

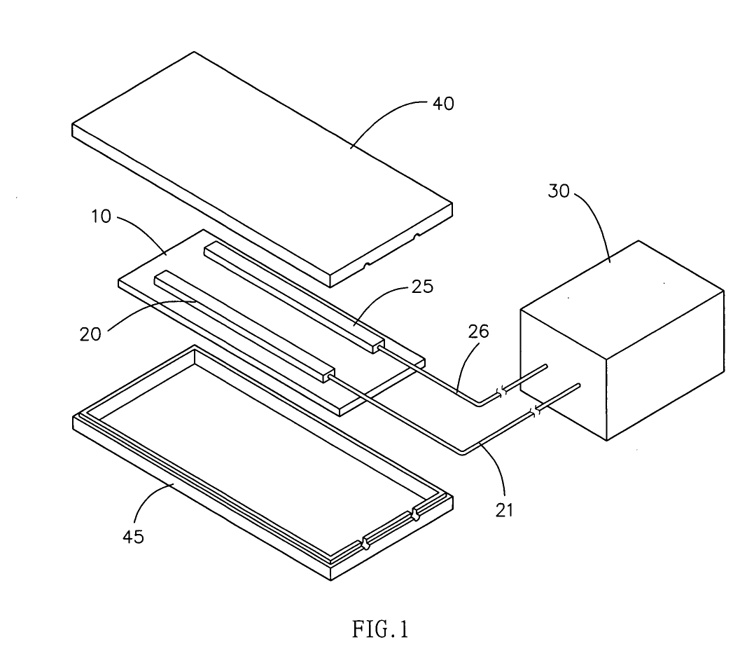

Referring to FIG. 1, there is shown a far infrared fuel-saver capable of providing far infrared light of adequate penetration and radioactivity according to the preferred embodiment of the present invention. The far infrared fuel-saver includes a semiconductor electro-thermal film 10 and two electrode strips 20 and 25. The electrode strips 20 and 25 are connected to a power supply 30.

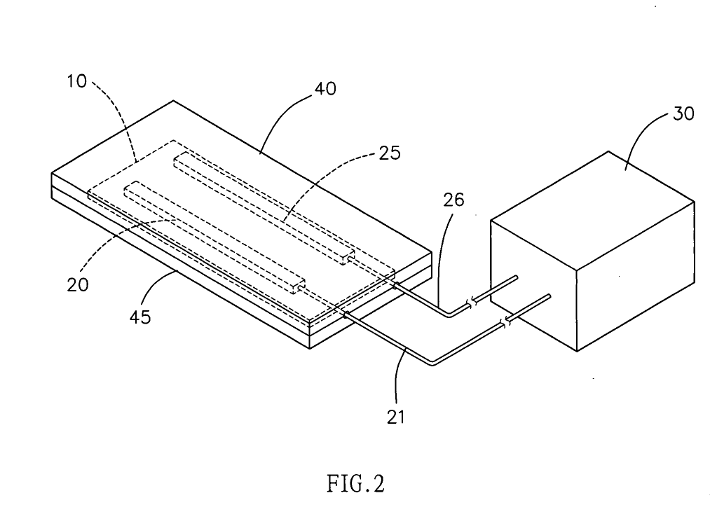

Referring to FIGS. 1 and 2, the semiconductor electro-thermal film 10 is capable of emitting a lot of far infrared light at the normal temperature. The electrode strips 20 and 25 are secured to a side of the semiconductor electro-thermal film. The electrode strips 20 and 25 can be made of various materials and are made of copper in the preferred embodiment in order to provide desirable electric and thermal conductivities. The larger the areas of contact of the electrode strips 20 and 25 with the semiconductor electro-thermal film 10 are, the higher are the electric and thermal conductivities. A proper gap is left between electrode strips 20 and 25. The smaller the gap between the electrode strips 20 and 25 is, the higher the thermal conductivity is.

The electrode strips 20 and 25 are connected to the positive and negative electrodes of the power supply 30 through wires 21 and 26, respectively. To prevent the semiconductor electro-thermal film 10 from burning because of an excessive high voltage provided from the power supply 30, the power supply 30 is a 12-volt battery in the preferred embodiment. The power supply 30, the wires 21 and 26, the electrode strips 20 and 25, and the semiconductor electro-thermal film 10 forms a short circuit in order to increase the thermal effect. The semiconductor electro-thermal film 10 and the electrode strips 20 and 25 are provided between two shells 40 and 45. Thus, the semiconductor electro-thermal film 10 and the electrode strips 20 and 25 are protected. Moreover, the far infrared fuel-saver can conveniently be used together with any engine in order to provide far infrared light of adequate penetration and radioactivity.

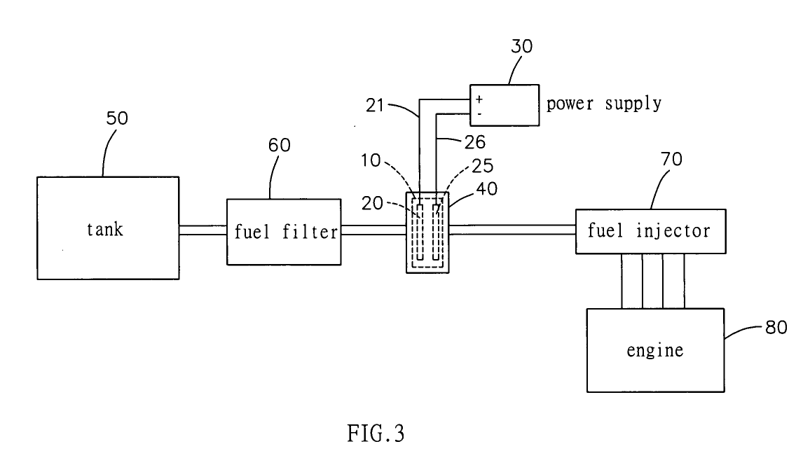

Referring to FIG. 3, the far infrared fuel-saver is used together with an engine 80 such as an internal combustion engine. Liquid fuel goes to a fuel injector 70 from a tank 50 through a fuel filter 60. The liquid fuel is minced in the fuel injector 70 before it is injected into the engine 80. The shells 40 and 45 of the far infrared fuel-saver are secured to a pipe (not numbered) positioned between the fuel filter 60 and the fuel injector 70. The semiconductor electro-thermal film 10 is aligned with the interior of the pipe. Thus, the liquid fuel in the pipe is subject to the far infrared light emitted from the semiconductor electro-thermal film 10. The molecules of the liquid fuel in the pipe are heated and minced by the far infrared light emitted from the semiconductor electro-thermal film 10. Thus, the liquid fuel can be combusted completely. If the rate of the provision of the liquid fuel is increased as required, the current provided to the semiconductor electro-thermal film 10 from the power supply 30 through the electrode strips 20 and 25 will be increased. Thus, the temperature of the semiconductor electro-thermal film 10 will be controlled between 80 degree and 100 degree centigrade. As the temperature gets higher, the wavelength of the far infrared light emitted from the semiconductor electro-thermal film 10 gets shorter, and the penetration and radioactivity of the far infrared light gets better.

Therefore, the molecules of liquid fuel are well minced so that the liquid fuel is combusted completely. The efficiency in generating energy through the combustion of the liquid fuel in the engine 80 is increased. The liquid fuel is saved. Because the combustion of the liquid fuel is complete, the carbon monoxide and un-combusted liquid fuel in the exhaust is little, and the deposition of carbon in the engine 80 is little. Thus, the pollution on the air is reduced. The wearing away of the engine 80 is minor so that the life cycle of the engine 80 is long.

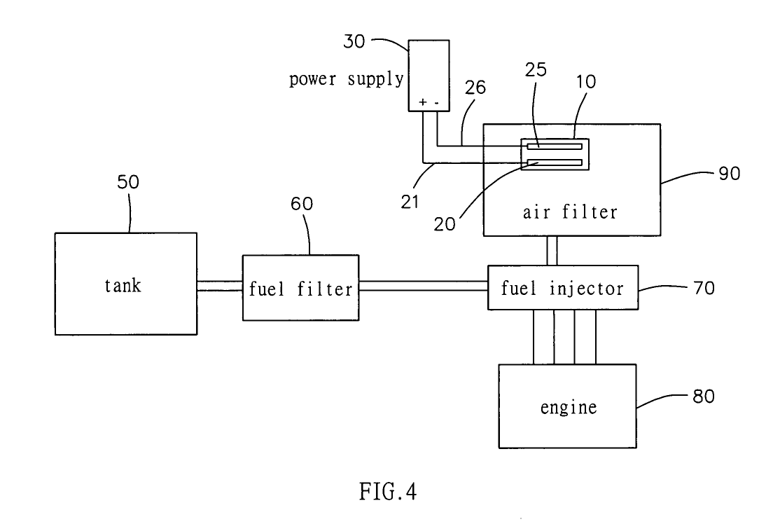

FIG. 4 shows a system similar to the system shown in FIG. 3 except including an air filter 90 connected to the fuel injector 70. In FIG. 4, the semiconductor electro-thermal film 10 of the far infrared fuel-saver is put in the air filter 90 in order to provide functions and effects similar to those described above.

The present invention has been described through the detailed description of the preferred embodiment. Those skilled in the art can derive variations from the preferred embodiment without departing from the scope of the present invention. Hence, the preferred embodiment shall not limit the scope of the present invention defined in the claims.

1. A far infrared fuel-saver comprising a semiconductor electro-thermal film and two electrode strips;
wherein the semiconductor electro-thermal film is capable of emitting a lot of far infrared light at the normal temperature, and the electrode strips are secured to a side of the semiconductor electro-thermal film, and the electrode strips can be made of various electrically conductive materials, and a gap is left between the electrode strips;
wherein the electrode strips are connected to the positive and negative electrodes of a power supply through two wires;
so that they are assembled into a far infrared fuel-saver capable of emitting far infrared light of high penetration and radioactivity.

2. The far infrared fuel-saver according to claim 1 wherein the electrode strips are made of copper in order to provide excellent electric and thermal conductivities.

3. The far infrared fuel-saver according to claim 1 wherein the larger the areas of contact of the electrode strips with the semiconductor electro-thermal film are, the higher the electric and thermal conductivities are, and the faster the temperature of the semiconductor electro-thermal film rises.

4. The far infrared fuel-saver according to claim 1 wherein the smaller the gap between the electrode strips is, the higher the thermal conductivity is, and the faster the temperature of the semiconductor electro-thermal film rises.

5. The far infrared fuel-saver according to claim 1 wherein the power supply is a battery.

6. The far infrared fuel-saver according to claim 1 comprising two shells for covering the semiconductor electro-thermal film and the electrode strips from top and bottom in order to provide protection of the semiconductor electro-thermal film and the electrode strips and facilitate the installation thereof.
